(19) United States
(12) Patent Application Publication
(10) Pub. No.: US 2004/0092261 A1
(43) Pub. Date: May 13, 2004

(54) Mass subscriber handling

(76) Inventors: Terho Kiiskinen, Tampere (FI); Mika Leppänen, Tampere (FI); Timo Aaltonen, Tampere (FI); Jari Marjoniemi, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/471,994

(22) PCT Filed: Mar. 16, 2001
(86) PCT No.: PCT/EP01/03040

(51) Int. Cl. H04M 3/42

(52) U.S. Cl. 455/435.1; 455/415

(57) ABSTRACT

The invention proposes a method for managing subscribers, comprising the steps of receiving (A1) a command list, receiving (A2) information for identifying a plurality of subscribers, and executing (A5) commands included in the command list on the subscriber identified by the subscriber identifying information. Thus, a information of a plurality of subscribers can be handled by a single method call. The invention proposes also a corresponding subscriber management device and a corresponding subscriber management system.

### FIELD OF THE INVENTION

The present invention relates to a method for mass subscriber handling.

### BACKGROUND OF THE INVENTION

The invention concerns Subscriber Management. By subscriber management, data are handled which are necessary to perform services for a subscriber. For performing subscriber management, it is necessary to handle the subscriber data. For example, it is necessary to change billing in case the costs of the service to which the subscriber has subscribed are changed.

When a client (for example, an operator) has to perform such subscriber management, it is necessary to perform as many method calls as there are subscriber handling operations. Corresponding International Mobile Subscriber Identity (IMSI) lists (or any other list identifying subscribers, e.g., MSISDN) have to be generated by the client and have to be transferred from the client to network node to which the subscribers are connected. A connection between the client and the network node can be established by using a TELNET connection, for example, which is a Transmission Control Protocol (TCP) connection. Thus, by using Telnet, the IMSI list files are sent to a subscriber database. When the operations are finished, the client does not get any acknowledge message from the subscriber database. Instead, the client has to make queries to the subscriber database to find out whether the started operation is finished or not.

This is in particular disadvantageous in case of mass subscriber handling. That is, an operator or a corresponding network control device has to perform all subscriber data handling for each subscriber individually.

Thus, according in the known subscriber handling, an operator or a client which wishes to effect certain amendments or changes regarding the subscriber data has to face a lot of workload.

### SUMMARY OF THE INVENTION

Therefore, the object underlying the invention resides in removing the above drawbacks of the prior art and in providing an easier method for mass subscriber handling.

This object is solved by a subscriber management device, comprising

a first receiving means for receiving a command list,

a second receiving means for receiving information for identifying a plurality of subscribers, and

a processing means for executing commands included in the command list to the subscribers identified by the subscriber identifying information.

Alternatively, the above object is solved by a for managing subscribers, comprising the steps of

receiving a command list,

receiving information for identifying a plurality of subscribers, and

executing commands included in the command list on the subscriber identified by the subscriber identifying information.

Thus, by the device and the method according to the invention, a client which intends to manage data of a plurality of subscribers can do this by a single method call.

Hence, the work load on operators is effectively reduced.

The subscriber identifying information may comprise a database query command for identify subscriber information in a database comprising subscriber data. Thus, a dynamic amount of subscribers can be handled. That is, a client can initiate processing of subscriber data even in case the client does not know how many and which subscribers are actually involved.

The command list may comprise a subscriber management interface, and the subscriber management interface may be used for transmitting the database query command to the subscriber management device. Hence, the processing may be started by predefined method call which can be established by the subscriber management interface.

The database query command may be a Structured Query Language (SQL) query command. Thus, the database may be configured according to well-known standards, such that an implementation can be easily achieved. The database may be a subscriber data register.

The subscriber identifying information may comprise a list of subscriber identifiers. Thus, as an alternative to the above, the subscribers data of which are to be processed can be individually identified.

The subscriber identifiers may be e.g. International Mobile Subscriber Identities (IMSI) or Mobile Subscriber International ISDN Number (MSISDN). Thus, the standard identifiers may be used such that an easy implementation is possible. Moreover, also a combination of both is possible such that pairs of IMSI and MSISDN are used.

An acknowledgment message may be sent to the first network element after the commands have been executed. Thus, the first network element (e.g., the client) may get information about the execution of the commands. Hence, it can be decided on the client side whether the execution has taken place. In addition, the acknowledgment message may include information whether the exectution was successful or not.

The command list may be sent via a File Transmission Protocol (FTP).

The command list may comprise a Subscriber Management interface, by which a first network element which has sent the command list may communicate with the network control element.

Furthermore, contents of the command list may be stored in the network control device. Thus, commands of the command list can be used again later. That is, the command list does not have to be sent every time a subscriber management has to be performed again.

Parts or all commands of the command list may be included in a macro, an execution of which may be initiated after receiving of the subscriber identification information.

The invention also proposes a subscriber management system, comprising subscriber management device as described above and a network element which is adapted to generate the command list and information for identifying subscribers, and to send the command list and the subscriber identifying information to the subscriber management device.

### BRIEF DESCRIPTION OF THE DRAWINGS

The present invention will be more readily understood with reference to the accompanying drawings in which:

FIG. 1 shows a diagram of the network structure according to a first embodiment,

FIG. 2 shows a signaling diagram of the procedure according to the first embodiment, and

FIG. 3 shows a signaling diagram of the procedure according to a second embodiment.

### DETAILED DESCRIPTION OF PREFERRED EMBODIMENTS

In the following, preferred embodiments of the invention is described in more detail with reference to the accompanying drawings.

The present invention provides a possibility to manage subscriber information or subscriber data of a plurality of subscribers with a single method call. Thus, the present invention enables a fast subscriber management.

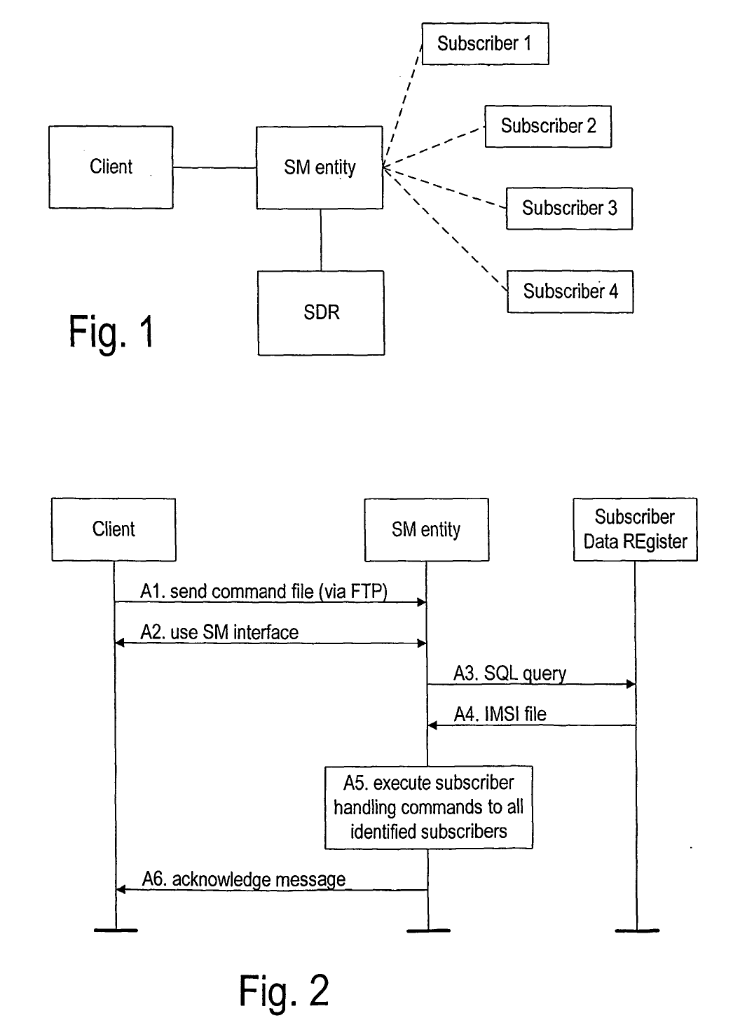

In FIG. 1, a principle network structure according to a first embodiment is shown. A plurality of subscribers 1 to 4 are associated to a Subscriber Management (SM) entity. This SM entity can be physically be provided in a suitable network control node. The SM entity is adapted to manage the subscribers associated thereto, that is, to amend subscriber data, to grant certain subscribers access to specific services and the like. The SM entity is also referred to as a subscriber management device.

The SM entity can access a subscriber data register (SDR). The SDR stores information of subscribers which is necessary to manage subscriber and which is in particular required to discriminate different access rights of the subscribers. Thus, the SDR stores information for authenticate service access of the subscribers and the like.

The subscriber data register (SDR) database may be a replicated copy of the Subscriber database located in a Network Entitiy (NE). Because the database in NE does not offer a mass query interface the database is replicated in a way that the replica allows mass queries (SQL queries) to be executed. While the replicated database is not the main copy of the subscriber database (updates and changes are replicated only from NE database to replica, not backwards) the SQL interface can be used only for queries (no data manipulation is allowed). That is, the SDR database is used only for queries, whereas the actual changes are made to the subscriber database. In turn, the changes the changes are automatically copied from the subscriber database to the SDR database in order to keep the SDR up to date. However, as an alternative, the SDR may be arranged as an independent database, and after changes have been made, a copy of it can be sent to the subscriber database.

Managing of subscriber data may be requested by a client. This may be a provider of certain services which can be accessed by the subscribers, but can also be the operator of the specific network to which the subscribers are subscribed. The client is also referred to as a network element which actually performs the necessary signaling and processing described below.

In case the client wishes to manage a plurality of subscriber data, the client sends a command file to the SM entity. The command file contains one or more Subscriber Management interface method calls with parameters. Thereafter, the client sends information for identifying the subscribers which are intended to be managed. According to the first embodiment, this is accomplished by sending an SQL (Structured Query Language) clause, by which a database containing subscriber information can be accessed.

In the following, the management procedure according to the first embodiment is described by referring to the signaling diagram shown in FIG. 2.

In step A1, the client sends a command file as described above to the SM entity. The command file (i.e., a command list) can be sent via a File Transport Protocol (FTP), for example, although the normal communication in the network according to the first embodiment may be performed by using Telnet, for example. The SM entity may offer an own interface (e.g., CORBA interface) to clients, while Telnet can be used when connecting directly to the Subscriber Management interface that NE offers.

In step A2, the client uses a subscriber management (SM) interface included in the command file to start the processing. The SM interface is a method call, that refers to the command file and includes an SQL clause. For example, the SQL clause or query may include a certain service. Thus, by this SQL clause, all subscribers may be identified which are subscribed to this service.

In step A3, the SM entity sends the SQL query to the SDR database. The SDR uses to the information given in the SQL clause for identifying those subscribers which match the query by the SQL clause. The SDR database then produces a list including the International Subscriber Identities (IMSIs) of all identified subscribers.

In step A4, the SDR database sends the IMSI list to the SM entity.

In step A5, the SM entity executes the commands included in the command list received in step A1 to all subscribers identified by the IMSI list. For example, the SM entity may alter access rights of the subscribers to certain services, changes billing of certain services and the like.

After executing the commands, the SM entity sends an acknowledge message to the client in step A6. Thus, the client will know that the commands have been executed.

In this acknowledge message, also information regarding success of the execution can be included. That is the SM entity can indicate in the acknowledge message which subscribers were successfully managed and which not. In particular, the SM entity can list all subscribers to which the commands were executed. In this case, the client gets aware of all subscribers which are actually subscribed to a certain service, for example. Hence, also a simple update of subscriber information for the client can be performed by the procedure according to the first embodiment.

Hence, according to the first embodiment, the processing workload for the client is reduced. That is, the client does not have to perform a subscriber management individually for each subscriber. In addition, the client does not even have to be aware of each subscriber. The client only has to identify a certain information or characteristic of the subscriber to which the commands are to executed. This information or characteristic is transmitted via the SQL clause to the SDR database which identifies or extracts the corresponding subscribers.

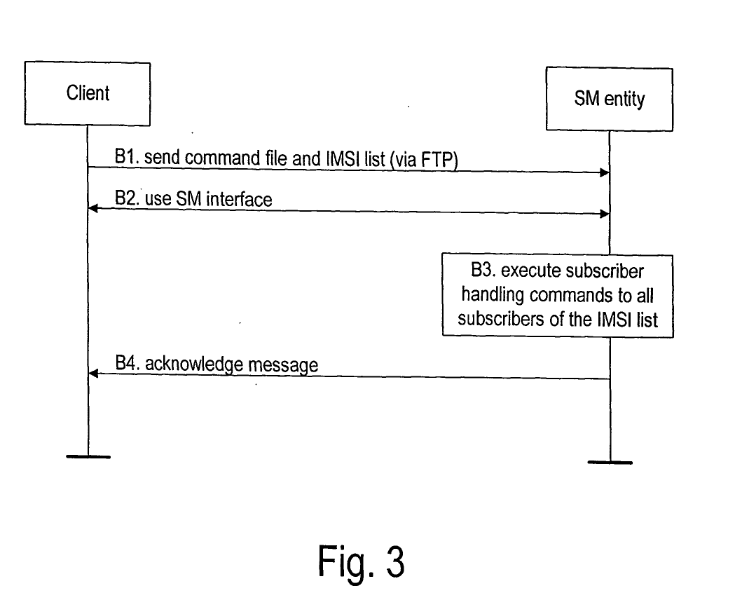

Next, a second embodiment is described with respect to the signaling diagram shown in FIG. 3.

The procedure according to the second embodiment is basically similar to that according to the third embodiment. Thus, only the differences are described in the following.

In step B1, the client sends a command list to the SM entity, but also sends an IMSI list to the SM entity. That is, in this case the client itself performs searching of the subscribers to which the commands included in the command list are to be executed. It is noted that a search does not have to be necessarily carried out. For example, in case the subscriber data of stolen mobile phones have to be handled (e.g., in order to prohibit any service for these), the client can input a list of stolen mobile phones.

Thus, the SM entity does not have to access a SDR database. Hence, according to the second embodiment, the SDR does not have to be provided, although it might be present for other purposes.

In step B2, the client uses the SM interface to start the processing (correspondingly to step A2 of the first embodiment).

In step B3, the SM entity executes the commands of the command list to all subscribers identified by the IMSI list (correspondingly to step A5 of the first embodiment).

After execution of the commands, the SM entity sends an acknowledgment message to the client in step B4 (correspondingly to step A6 of the first embodiment). As in the first embodiment, the acknowledgment message may include information about success or failure of the execution of the commands and the like.

Thus, according to the second embodiment, the hardware necessary may be reduced, and also the number of processes may be reduced.

It is noted that the invention is not limited to the embodiments described above. Various amendments and modifications are possible.

In particular, the embodiments may be combined. For example, a plurality of subscribers have applied for a certain service provided by the client. In this case, the client knows which subscriber data are to be processed. Hence, the client can use the procedure of the second embodiment to perform a corresponding subscriber management. In particular, the procedure of the second embodiment is useful in cases in which an SQL query is not possible (as in the above example).

On the other hand, in case the client would like to process data of all subscribers of a certain service, the client may use the procedure of the first embodiment. In this case, it is not necessary to provide an IMSI list by the client. In addition, the client obtains information about all subscribers which are actually subscribed to the service.

Furthermore, the IMSI list or IMSI file may be a Mobile Subscriber ISDN number (MSISDN) file. Alternatively, the file/list could contain IMSIs and/or MSISDN numbers. If both are listed then the list consists of IMSI/MSISDN pairs.

Moreover, the command list, which can include or be a macro comprising all or only a part of the commands of the command list, can be stored in the SM entity. That is, in case the client wants to repeat the procedure, it is not necessary to send the command list again. The client then simply uses the SM interface (step A2) to start the processing again.

1. A subscriber management device, comprising
a first receiving means for receiving a command list,
a second receiving means for receiving information for identifying a plurality of subscribers, and
a processing means for executing commands included in the command list to the subscribers identified by the subscriber identifying information.

2. The device according to claim 1, further comprising a subscriber database, wherein the subscriber identifying information comprises a database query command for identify subscriber information in the database.

3. The device according to claim 2, wherein the command list comprises a subscriber management interface, and wherein the subscriber management interface is used for transmitting the database query command to the subscriber management device.

4. The device according to claim 2, wherein the database query command is a Structured Query Language (SQL) query command.

5. The device according to claim 2, wherein the database is a subscriber data register (SDR).

6. The device according to claim 1, wherein the subscriber identifying information comprises a list of subscriber identifiers.

7. The device according to claim 6, wherein the subscriber identifiers are International Mobile Subscriber Identities (IMSI).

8. The device according to claim 6, wherein the subscriber identifiers are Mobile Subscriber International ISDN Number (MSISDN).

9. The device according to claim 6, wherein the subscriber identifiers are International Mobile Subscriber Identities (IMSI)/Mobile Subscriber International ISDN Number (MSISDN) pairs.

10. The device according to claim 1, further comprising a sending means for sending an acknowledgment message to the first network element after the commands have been executed.

11. The device according to claim 1, wherein the first receiving means is adapted to receive the command list via a File Transmission Protocol (FTP).

12. The device according to claim 1, wherein the command list comprises an subscriber management interface by which a first network element which has sent the command list may communicate with the network control element.

13. The device according to claim 1, further comprising a storing means for storing contents of the command list.

14. The device according to claim 1, wherein parts or all commands of the command list are included in a macro, wherein the processing means may initiate execution of the macro after the receiving means has received the subscriber identification information.

15. A subscriber management system, comprising
a subscriber management device according to one of the claims 1 to 14 and
a network element which is adapted to generate the command list and information for identifying subscribers, and to send the command list and the subscriber identifying information to the subscriber management device.

16. A method for managing subscribers, comprising the steps of
receiving (A1; B1) a command list,
receiving (A2; B2) information for identifying a plurality of subscribers, and
executing (A5; B3) commands included in the command list on the subscriber identified by the subscriber identifying information.

17. The method according to claim 16, wherein the subscriber identifying information comprises a database query command for identifying (A3, A4) subscriber information in a subscriber database.

18. The method according to claim 17, wherein the database query command is a Structured Query Language (SQL) query command.

19. The method according to claim 17, wherein the database is a Subscriber Management Mediator database.

20. The method according to claim 16, wherein the subscriber identifying information comprises a list of subscriber identifiers.

21. The method according to claim 20, wherein the subscriber identifiers are International Mobile Subscriber Identities (IMSI).

22. The method according to claim 20, wherein the subscriber identifiers are Mobile Subscriber International ISDN Number (MSISDN).

23. The method according to claim 20, wherein the subscriber identifiers are International Mobile Subscriber Identities (IMSI)/Mobile Subscriber International ISDN Number (MSISDN) pairs.

24. The method according to claim 16, further comprising the step of sending (A6; B4) an acknowledgment message to the first network element after the commands have been executed.

25. The method according to claim 16, wherein the command list and the subscriber identifying information are transmitted via a File Transmission Protocol (FTP).

26. The method according to claim 16, wherein the command list comprises an subscriber management interface by which a first network element which has sent the command list may communicate with a network control element for performing the method.

27. The method according to claim 26, further comprising the step of storing contents of the command list.

28. The method according to claim 16, wherein the command list and information for identifying subscribers are generated by a network element.

29. The method according to claim 16, wherein parts or all commands of the command list are included in a macro, an execution of which is initiated after receiving of the subscriber identification information.
